(19) United States
(12) Patent Application Publication
(10) Pub. No.: US 2026/0002270 A1
(43) Pub. Date: Jan. 1, 2026

(54) METHOD TO ENCLOSE A HYDROGEN AND OXYGEN GENERATING APPARATUS IN AN ENCLOSURE AND ENCLOSURE ADAPTED FOR A HYDROGEN AND OXYGEN GENERATING APPARATUS

(71) Applicant: GREEN HYDROGEN SYSTEMS A/S, Kolding (DK)

(72) Inventors: Bo MORTENSEN, Kolding (DK); Tommy LYSDAL NIELSEN, Kolding (DK); Rasmus WORSØE, Kolding (DK)

(21) Appl. No.: 19/161,602

(22) PCT Filed: Mar. 4, 2024
(86) PCT No.: PCT/EP2024/055589

§ 371 Date: Sep. 2, 2025

(30) Foreign Application Priority Data
Mar. 2, 2023 (DK) PA202300198

(51) Int. Cl. C25B 9/60; C25B 9/73

(52) U.S. Cl. CPC C25B 9/60; C25B 9/73

(57) ABSTRACT

An enclosure adapted for a hydrogen and oxygen generating apparatus arranged in a movable has an interior and an interior surface and an exterior surface whereby the hydrogen and oxygen generating apparatus comprises at least one electrolyser stack adapted for electrolysing water to hydrogen product gas and oxygen product gas and accompanying gas and electrolyte handling equipment. The exterior surface of the enclosure comprises at least a heat insulating, flexible polymer cover element which is attached to a metal frame.

The present invention relates to a method of enclosing a hydrogen and oxygen generating apparatus in an enclosure. Further, the present invention relates to an enclosure adapted for enclosing a hydrogen and oxygen generating apparatus.

### BACKGROUND OF THE INVENTION

Movable units comprising hydrogen and oxygen generating apparatus are gaining popularity, as they may be produced as series produced units and easily transported to a cite, where hydrogen is required and where electric power is available. The units are installed on cite in the open and may even be moved from one cite to another. As the units are exposed to the elements, and comprise delicate and temperature sensitive tackle, each unit must be enclosed in some sort of protective sheath to ensure somewhat predictable temperature levels inside of the unit and protection against precipitation. Such enclosures have usually been made with hard board materials with polymer finish of durable paint or varnish. The hard board enclosures leave open some issues such as serviceability of parts inside the unit, which demands either door access at a multitude of points, or a dis-assemble option which may be costly to establish. Also, door access demands that there is room for the swing movement of a door at multiple locations, which adds to the footprint of the unit. Also, in all such units there is a small risk of leaking gasses, notable oxygen and hydrogen, which at the right concentration may suddenly and quite violently combust into water, releasing a pressure wave. Such a pressure wave may splinter and accelerate parts of a hard board enclosure around the unit, and thereby cause injury to persons and equipment in the vicinity of the unit.

### SUMMARY OF THE INVENTION

In a first aspect, the invention concerns a method to enclose a hydrogen and oxygen generating apparatus in an enclosure comprising a frame, an interior, an interior surface and an exterior surface, wherein the hydrogen and oxygen generating apparatus comprises
at least one electrolyser stack adapted for electrolysing water to hydrogen product gas and oxygen product gas, and
product gases and electrolyte handling equipment,
wherein the following steps are performed:
a) assemble and mount the hydrogen and oxygen generating apparatus into the metal frame,
b) add and secure heat insulating flexible polymer cover elements to the metal frame.

Thereby a moveable unit (8) for transporting/moving hydrogen and oxygen generating apparatus may be provided.

The mentioned components of the hydrogen and oxygen generating apparatus are attached to the frame. This facilitates the movability of the enclosure and the components of the hydrogen and oxygen generating apparatus.

Use of flexible polymer cover elements is a superior way of mitigating the risks of possible sudden temperature driven expansion of gasses inside the enclosure as the flexible cover elements may easily be made light weight, such that even if parts thereof are accelerated into high velocity, they will not comprise energy enough to cause injury to persons or installations and the flexible nature of the cover elements will also prevent penetration power of even high velocity fractions of cover elements. The flexible polymer cover also grants a lower weight, and thereby easer transportation of the unit.

In embodiment of the invention, an electrically conductive cover is added along with the flexible polymer cover elements and secured to the metal frame.

The electrically conductive cover will when connected to electric ground at a multitude of locations provide an excellent measure against the accumulation of electric charge, which is otherwise always a risk with flexible polymers, which extends over larger areas. The provision of the electrically conductive cover as a separate unit and not embedded in the flexible polymer cover element allows for a larger range of available flexible covers, and it is also easier to step up on functions such as isolation, which may be done independently by simply adding to the thickness of the one flexible polymer cover element, or by providing extra layers thereof.

In an embodiment intermediate profiles are added onto the metal frame by attaching first attachment surfaces of the intermediate profiles to the metal frame and the flexible and heat insulating polymer cover elements are secured to second attachment surfaces of the profiles on sides of the metal frame and on upward facing surfaces of the metal frame and further, mounting lists are provided externally of the flexible polymer cover elements along the intermediate profiles whereby the mounting list are secured by through going fasteners adapted to pierce the mounting lists, the flexible cover element, the electrically conductive cover and the second attachment surfaces of the intermediate profiles.

The use of intermediate profiles will ensure, that there is a uniform and even surface for the mounting of the flexible polymer elements and any irregularities of the metal frame, such as assembly flanges may be accommodated by the intermediate profiles. Also, the intermediate profiles are made from a material such as stainless-steel plating which is easier to process than the rather thick-walled metal frame parts, for obtaining fastening points such as screw holes or rivet holes.

In an embodiment zip operated openings are provided and allows access through the flexible polymer cover elements and the electrically conductive cover to the interior of the enclosure.

The use of zips in flexibles of this nature is well known, however it is not evidently the best solution for an enclosure of a hydrogen and oxygen generating apparatus, as zip lines leaves small openings between individual lock elements. However, these vent openings will ensure a natural ventilation of the unit and are thus un-expectedly advantageous.

In an embodiment the following further step is performed: extend tongue elements of lower edges of at least one opening into the interior of the enclosure at a downward sloping angle with respect to a horizontal plane.

If a zip operated opening is provided at a location, where the tongue is desired, it would be natural to extend the lower edge of such a zip operated opening into the inner space of the enclosure. The tongue ensures that any effluent ejected from the electrolyte handling equipment within the enclosure is guided into interior of the enclosure, where a suitable receptacle for such effluent such as a drip pan may be provided.

In a second aspect, the invention concerns an enclosure adapted for a hydrogen and oxygen generating apparatus, which comprises a frame part, an interior, an interior surface, and an exterior surface, and wherein the hydrogen and oxygen generating apparatus comprises
at least one electrolyser stack adapted for electrolysing water to hydrogen product gas and oxygen product gas, and
accompanying gas and electrolyte handling equipment.

Preferably, the exterior surface of the enclosure comprises at least a heat insulating flexible polymer cover element which is attached to a metal frame.

Thereby a moveable unit (8) for transporting/moving hydrogen and oxygen generating apparatus may be provided.

By such an element a safer enclosure for a hydrogen and oxygen generating apparatus in a movable unit is provided.

The mentioned components of the hydrogen and oxygen generating apparatus are attached to the frame. This facilitates the movability of the enclosure and the components of the hydrogen and oxygen generating apparatus.

In an embodiment intermediate profiles are adapted to be attached onto the metal frame through first attachment surfaces of the intermediate profiles, and the flexible and heat insulating polymer cover elements are adapted to abut second attachment surfaces of the intermediate profiles along sides and upward facing side of the metal frame, and lastly mounting lists are secured externally of the flexible polymer cover elements along the intermediate profiles by through going fasteners adapted to pierce the lists, the flexible cover element and the second attachment surfaces of the intermediate profiles.

The intermediate profiles may, by way of the two sets of attachment surfaces, allow some distance in the outward direction of the enclosure between the two sets of surfaces. This may come in very handy as thereby the polymer cover elements may be arranged at a distance from protruding elements such as flange connections between possible sub-assemblies of the movable unit.

In an embodiment electrically conductive covers are arranged to extend along with the flexible polymer cover elements and are fixated with the flexible polymer cover elements between the mounting lists and the second attachment surfaces of the intermediate profiles.

Separate conductive covers for the purpose of mitigating possible build-up of electric charge on the flexible polymer cover elements allows for a speedy redesign of the enclosure such as adaptations to arctic conditions as explained above. It is however mentioned that flexible cover elements comprising antistatic fillers are also an option, in case the such becomes commercially available in the desired amounts, for the assurance against electrical charge bult up on the surfaces of the flexible polymer cover element.

In an embodiment, zip operated openings are provided to allow access through the flexible polymer cover elements and through the electrically conductive cover to the interior of the enclosure.

As serviceability is required from nearly all angles of the enclosure, the use of zip openings is advantageous, not just from a cost perspective, but also in terms of a space saving measure around the enclosure.

In an embodiment tongue elements of lower edges of at least one opening extend into the interior of the enclosure at a downward sloping angle with respect to a horizontal plane.

The use of tongue elements formed integrally with the flexible polymer cover elements shall provide a means for guiding any effluent ejected from components within the enclosure to a receptacle or the like.

In a further aspect, the invention can be a mobile unit, for example as defined above in relation to the second aspect of the invention, and manufactured by the above mentioned process according to the first aspect of the invention. More specifically the mobile unit (8) may be mobile or moveable hydrogen and oxygen generating plant, wherein the mobile/movable hydrogen and oxygen generating plant comprises an enclosure (2) configured for enclosing a hydrogen and oxygen generating apparatus (1), wherein the enclosure (2) is defined by at least a metal frame and wherein the enclosure comprises
an interior (3),
an interior surface (4), and
an exterior surface (5),
wherein the hydrogen and oxygen generating apparatus (1) comprises
at least one electrolyser stack (6) adapted for electrolysing water to hydrogen product gas and oxygen product gas and accompanying gas, and
electrolyte handling equipment (7),
wherein the hydrogen and oxygen generating apparatus (1) is arranged in the metal frame part (9), and
wherein the exterior surface (5) of the enclosure (2) comprises at least a heat insulating flexible polymer cover element (10) which is attached to the metal frame part (9).

The mobile unit (8), e.g. in the form of the mentioned mobile/movable hydrogen and oxygen generating plant may comprises any of the further features of the enclosure as described in connection with the 2^{nd} aspect of the invention, or may be made in the process defined in connection with the embodiments of the first aspect of the invention.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor requires the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows 6 side-view representations of exterior surfaces of an enclosure according to the invention,

FIG. 2 is 3D representation of a sectionalised part of an inside corner of the enclosure and the profiles whereto the enclosure is fastened,

FIG. 3 is a 3D representation of a section along a horizontal plane of the corner seen in FIG. 2 viewed from above,

FIG. 4 shows a partial sectional view of the corner shown in FIG. 3,

FIG. 5 is an enlarged view of a detail from FIG. 4,

FIG. 6 shows a 3D view of the hydrogen and oxygen generating apparatus 1 along with product gasses and electrolyte handling equipment 7 along with the metal frame 9,

FIG. 7 is a 3D view of the plant shown in FIG. 6, but from a different angle,

FIG. 8 shows a 3D representation of a sectional view through a corner part of the plant whereto the corner shown in FIG. 3 and FIG. 4 shall fit,

FIG. 9 shows a full 3D view of a drip pan 28,

FIG. 10 shows a 3D representation of the intermediate profiles 11, rafters 29, and mounting lists 20,

FIG. 11 shows a sectional view of a 3D representation of the mounting of power line feed through blocks,

FIG. 12 shows a detail of the mounting of the slide sockets 37,

FIG. 13 shows a set of mounting brackets for the enclosure wall layers,

FIG. 14 is a schematic display of a section through an automatically operated flow through opening, and

FIG. 15 shows a pneumatically operated opening part.

### DETAILED DESCRIPTION OF THE EMBODIMENTS

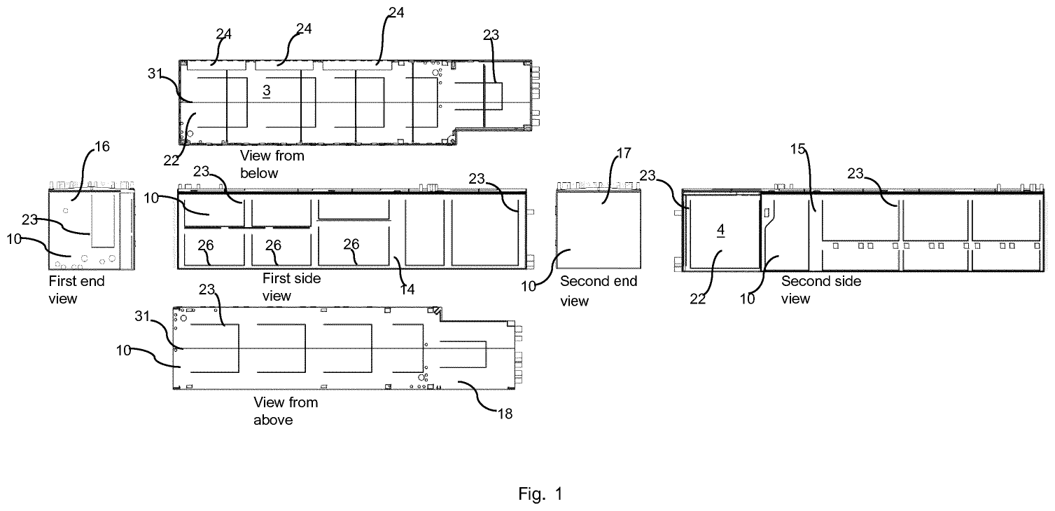

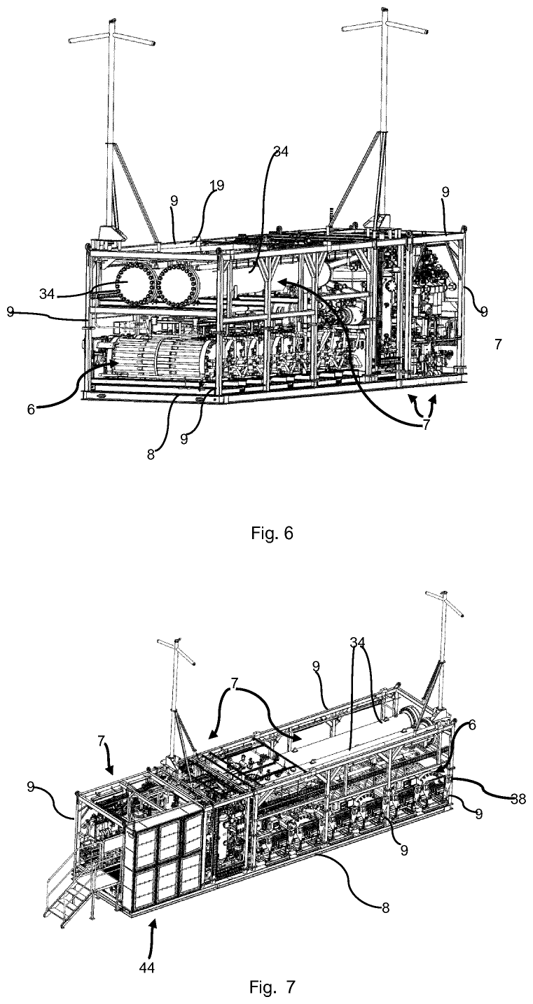

FIG. 1 shows an enclosure 2 having an interior 3 and an interior surface 4 and exterior surface 5. The enclosure 2 is arranged to enclose a hydrogen and oxygen generating apparatus 1, shown in FIGS. 6 and 7, which comprises at least one electrolyser stack 6 adapted for electrolysing water into hydrogen product gas and oxygen product gas and shall also comprise product gases and electrolyte handling equipment 7. The electrolyser stacks 6 and product gasses and electrolyte handling equipment 7 are assembled in a movable unit 8, which comprises a metal frame 9. Thus, the movable unit 8 may be partially or fully assembled at a factory and loaded onto a truck for transport to a cite, where the production of hydrogen and/or oxygen is desired.

Flexible, polymer cover elements 10, which are also heat insulating, are added to the metal frame part 9 such that the electrolyser, electrolyte and gas handling equipment are shielded against the influence of the elements such as rain and wind. In this way delicate electronic parts and mechanically sensitive elements, which are arranged in the movable unit 8 will not be directly exposed to rain, wind or sun.

Further, the insulating property of the polymer cover elements 10 shall aid in securing a somewhat uniform temperature in the interior of the enclosure 2 which will make temperature control of especially the electrolyser stacks easier. The flexibility and also lighter weight of the cover elements will also mitigate the possible risks of sudden reaction of accidentally leaked oxygen and hydrogen gasses within the enclosure.

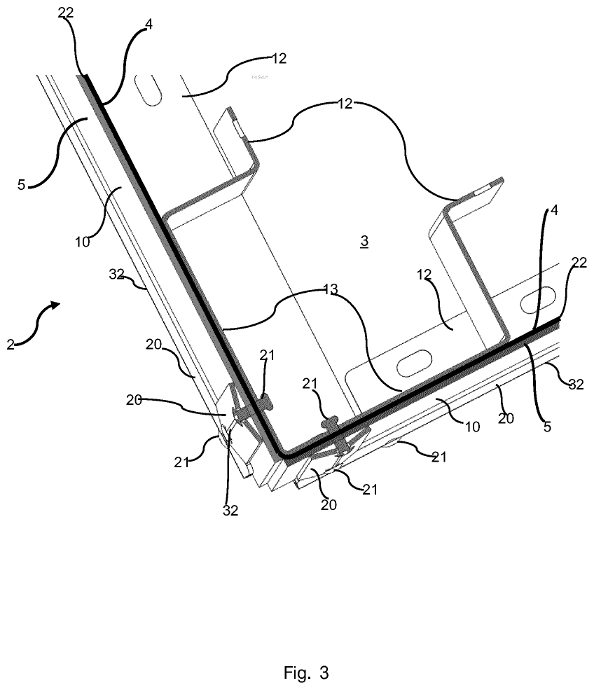

A further cover 22 may be provided along with the flexible polymer cover elements 10, and preferably this further cover is rendered electrically conductive, while being flexible and light weight. Electric conductivity may be provided to the further cover 22 by adding electrically conductive elements such as metal fibres or particles or metal oxides and/or a carbon based compound or combinations of the mentioned to the polymer composition of the further cover 22. An embedded fibre sheet like element may render the further cover 22 tear resistant. By the presence of this further cover 22, the tendency to build up static electric charge of the flexible polymer cover elements 10 may be mitigated, such that flash discharges caused by static electricity is prevented. Preferably the further cover is added along the surface of the flexible polymer cover elements facing the interior 3 of the enclosure 2. This is seen in FIGS. 5 and 3, however throughout, the further cover 22 shall be provided along all inside surfaces of the flexible polymer cover element even if not disclosed in some of the figures of the drawing.

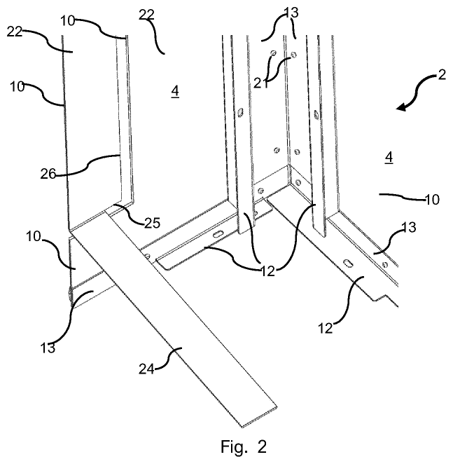

Intermediate profiles 11 are disclosed in FIGS. 2, 3, 4 and 5 and are added onto the metal frame 9 by attaching first attachment surfaces 12 of the intermediate profiles 11 to the metal frame 9. The intermediate profiles 11 allows easy mounting of the flexible cover element 10 and the further cover 22 as the intermediate profiles 11 may be made from a softer and thin walled material such as stainless steel plates. Further the intermediate profiles 11 also allows the mounting of the flexible polymer elements at a distance from the metal frame 9, which lends some flexibility to the construction process as the intermediate profiles 11 may be designed at a late stage an allow for accommodation of elements which does not easily fit within the metal frame 9 of the movable unit. Screw, bolts or even glue may be utilized for the fastening of the first attachment surfaces to the vertical and horizontal struts of the metal frame 9. If piecing attachment means such as screws are used, it is noted, that fewer screw holes are to be made in the metal frame element, than would be the case if the flexible polymer cover elements 10, 22 were to be fasted directly onto the metal frame parts using a screw, rivet or bolting technique, and further, the intermediate profiles may easily be shaped to accommodate irregularities of the metal frame, such as flanges for the interconnection of possible sub-assemblies of the movable unit 8.

The flexible (and heat insulating) polymer cover elements 10 may easily be added to second attachment surfaces 13 of the intermediate profiles to thereby cover all sides 14, 15, 16, 17 of the metal frame 9.

Preferably the polymer cover elements 10 are made from particularly durable polymer such as PVC and to assure good thermal insulation, a foamed PVC may be chosen. The thickness may vary according to the needed thermal properties, but it is preferred, that the material has a thickness of no less than 3 mm and has a weight of around 1300 g/m². The cover element preferably also comprises an embedded fabric for added strength, such as a PES based fabric. It is noted that the electrically conductive cover 22 has a weight of around 630 g/m². It is preferred, that the weight sum of the flexible cover element 10 and electrically conductive cover 22 does not exceed 1930 g/m², and more preferred does not exceed 2000 g/m². It is noted, that in case the hydrogen and oxygen generating apparatus is to be deployed in an arctic zone, it is preferred to employ a thicker and thus heavier flexible polymer cover, subsidiarily to use a number of cover elements 10 on top of each other to reach a desired insolation value.

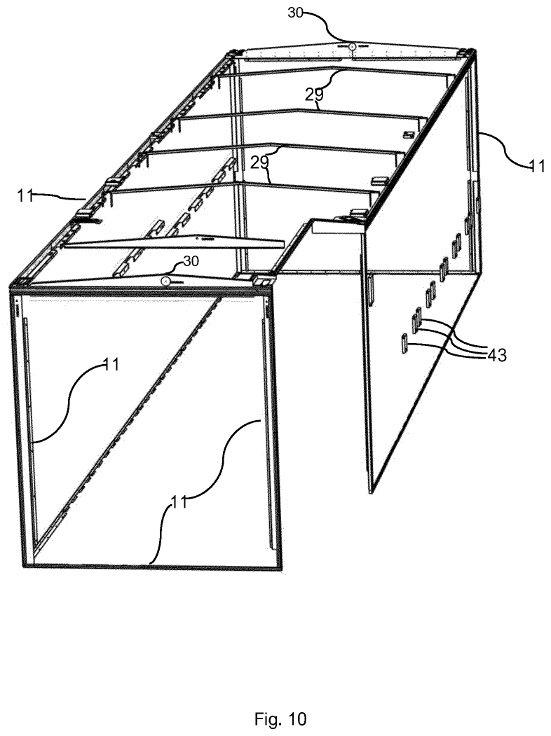

As seen in FIGS. 1 and 10 upward facing surface 18 of the metal frame 9 may be covered in this fashion, however here the intermediate profiles are preferably shaped as rafters 29 (best seen in FIG. 10) and are adapted to bridge the distance between upper horizontal frame elements 19 at the first side 14 and at the second side 15 of the enclosure 2. At outer ends of the rafters 29, inverse U-shaped brackets are fasted, and adapted to be mounted onto an upper horizontal metal frame part 9. A length axis centreline 31 of the upwards facing side 18 of the flexible cover element 10, is lifted by the rafters 29 and thereby fashion the upward facing side 18 as a gable roof 30. This will prevent water from accumulating on the upward facing side 18.

Externally of the flexible polymer cover elements 10, mounting lists 20 are provided along the intermediate profiles 11 and the lists 20 are secured by through going fasteners 21 adapted to pierce the mounting lists 20, the flexible cover element 10, electrically conductive cover 22, and the second attachment surfaces 13 of the intermediate profiles 11. This is best seen in FIGS. 3 and 5. Further in FIG. 5, a mounting list 20 is shown in a sectional view, and here it is seen, that the lists 20 have a V shaped profile which, when the through going fasteners 21 are provided at the apex 31 of the V, will ensure, that the two legs of the V shall each be pressured towards the underlying flexible polymer cover element 10 and electrically conductive cover 22.

The through going fasteners 21 may be shaped as bolts, screws, or rivets or they may even be shaped as flexible ropes or wires which are threaded through holes in the lists, the covers and the intermediate profiles, to ensure pressurization forces between the mounting lists 20 and underlying second attachment surfaces 13 of the intermediate profiles 11. In the example given in the figures, hollow rivets have been chosen as they are easy to mount and will provide a predictable and consistent tension between the mounting list 20 and the second attachment surface. Preferably pre-prepared through going holes are provided in both the mounting lists 20, along their apex lines, and through the material of the second attachment surfaces 13, such that the rivets shall be very easy to mount.

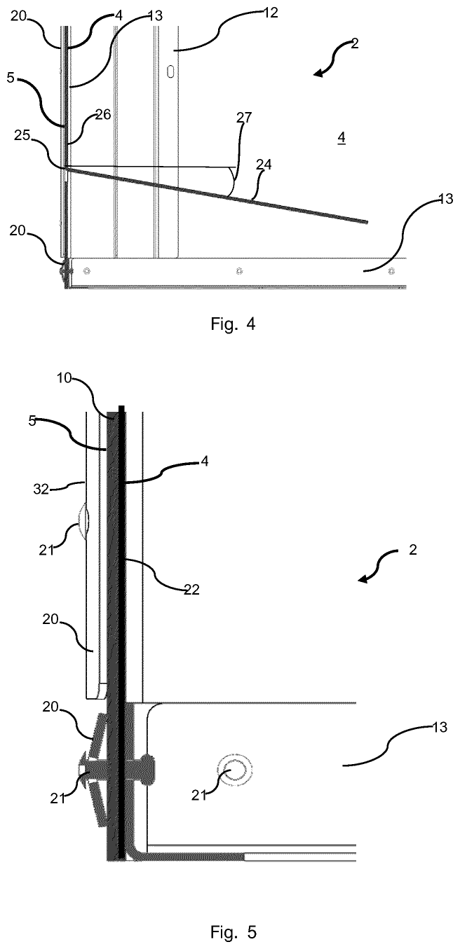

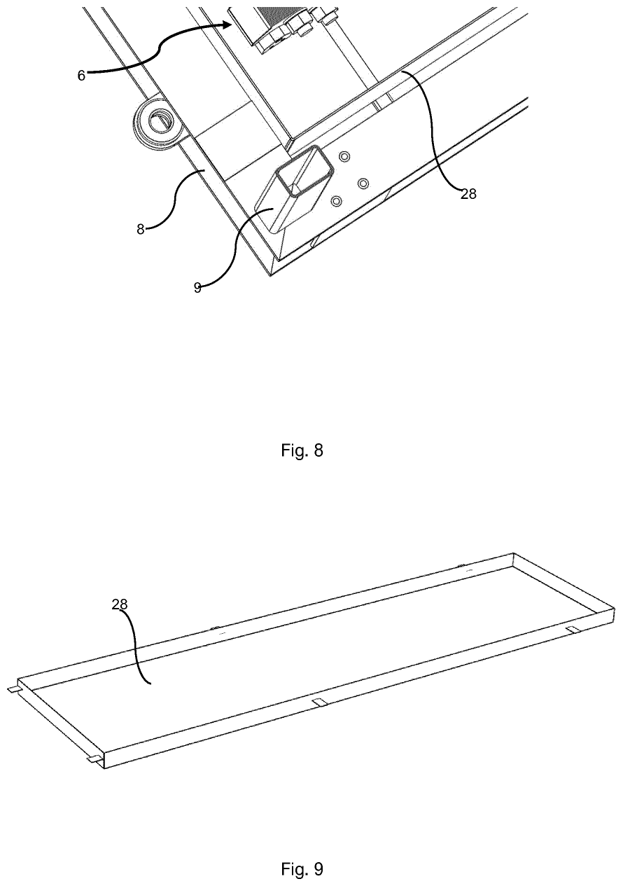

In FIG. 1, a number of tongue elements 24 are seen and in FIG. 2 a 3D partial section through such a tongue 24 is seen. The tongue elements 24 extend inwardly from lower edges 25 of the zip operated openings with tongues 26 and into the interior of the enclosure. Only 3 of the multitude of zip operated openings 23 are zip operated openings with tongues 26 as seen in FIG. 1. The tongues are arranged with a downward sloping angle 27 as seen in FIG. 4 in order to facilitate flow into the drip pan. The tongues 24 all extend into a so-named drip pan 28, visible in FIG. 8 and shown in its entirety in FIG. 9. The drip pan 28 is basically corrosion resistant pan adapted to accumulate any effluents leaking from the above mounted electrolyser stacks 6 and electrolyte handling equipment 7, such as the separators 34. Also pumps, filters and heat exchangers charged with the electrolytes are provided above the drip pan 28 and any pipe interconnecting this multitude of components may comprise a leak hazard. Due to the pressure inside the mentioned vessels, a leak may cause a jet of fluid to shoot out towards the enclosure, and in this case, it is desirous that the leaked fluid is guided towards the drip pan 28. In FIG. 1, in the view from below, there are only tongues 24 extending inwardly from the first side 14, but in principle it would be possible to also arrange tongues extending from lower edges of zip operated openings 23 at the second side 15 and into the drip pan 28, however control valves, wiring and piping in this area prevents this measure from being realized.

On the first side 14, the second side 15, the first end side 16, and on the upward facing side zip operated openings 23 are provided, where zips (not shown) are inserted in both the flexible polymer cover elements 10 and in the electrically conductive cover 22 such that access from the exterior is allowed at any point, where service requiring instruments and units are arranged as part of the hydrogen and oxygen generating apparatus 1. Service openings in the flexible polymer cover elements are thus providable at any desirable point, and hinges, door frames, door locks, movement space for hinged doors, and brackets for securing opened doors need not be provided and the zip operated access openings are easily secured in the un-zipped states, such as by being rolled up. As seen in FIG. 1, the zip operated openings have zip lines following 3 sides, and thereby defines a flap like element, which remains attached to the enclosure when un-zipped, however zips may be provided along the entire perimeter of an opening and thereby allow an opening flap to be detached completely from the enclosure. It is noteworthy, that compared to board like enclosure with a multitude of openings, the flexible cover element also is considerably lower in weight, which means lower total weight of the unit, which adds to ease of transport.

It is noteworthy that the proposed flexible enclosure also allows deployment of electrolyser units closer to residential areas or infrastructure such as roads and harbours due to the decreased risk of formation of energy rich explosive gas mixtures within the enclosure, as well as decreased risk of high velocity heavy pieces spreading away from the unit in the event of a sudden unplanned disassembly.

To mitigate the risk of hydrogen accumulation inside of the movable unit 8, automatically operated flap like covers 23A for air flow-through areas 23B or openings may easily be provided in the enclosure 2, and both the lightness and the flexible nature of the flexible cover elements 10 allows for easy and light-weight construction of such automatically operated openings. In effect, some or all of the zip-line surrounded openings 23 are simply supplanted or supplemented with closures, where built-in magnets 23E; 23F are provided to maintain a flap like cover 23A in a closed state when needed and actuators 23C are provided to force edges of a flap like cover 23A away from the remainder of the unit 8 to thereby open an air flow-through area.

A first multitude of magnets 23E shall be provided on or possibly embedded the flap like cover 23A around edges thereof, and a further multitude of magnets 23F shall be provided on the intermediate profiles 11 (as shown in FIG. 14) or on the metal frame 9. When the actuator 23C operates the frame like piece 23D to close the opening 23B, the two sets of magnets 23F and 23E shall ensure a reasonable tight closure of the opening 23B even if the light-weight nature of the frame like piece 23D does not provide the possibility of a sealing feature. When a further security against leakage is desired, the zip 23 may optionally be manually closed.

The actuator 23C may be a usual pneumatically or electrically operated actuator connected at one end to a frame like piece 23D, such as a plastic frame, arranged around and fastened to the edges of the flap like cover 23A. With the actuator at its other end connected to a metal frame part 9 of the movable unit 8, the flap like cover 23A becomes manoeuvrable between an opened and a closed state, the closed state being disclosed in FIG. 14. If both of a zip operated opening 23 and magnetic and actuator operated closure is provided for the same flap-like cover 23A, the zip 23 may be manually operated and in use when the unit is being transported or remain in a closed down state for a somewhat longer duration.

A built-in pneumatically operated element in double walled parts of a flap like cover, such as a polymer hose 45; 46 seen schematically in FIG. 15, adapted to change shape when exposed to internal pressure (shown at 46) above the surrounding pressure, may be provided to enable controlled movement of a flap or flap like cover 23A (not disclosed in FIG. 15) to allow increased air flow through an opening for the enablement or enhancement of natural or forced ventilation of the interior of the unit 8. This would be an alternative to the above described well known pneumatic or electric actuator, and the advantages of this option is that the frame like piece 23D and the electrically or pneumatic actuator could all be omitted, and only the magnets and the built in pneumatically operated polymer hose would be needed. The hose 44, 45 is made with one side thereof being somewhat longer than the other, which accounts for the movement between the un-pressurised and the pressurised states shown in FIG. 15. A multitude of the such element each having a controllable supply of compressed air (not shown) would be able to releave a multitude of magnets in and out of engagement and thereby open or close an air flow through opening.

Openings of this kind are best provided both at lover parts of the enclosure and at upper parts to enable natural ventilation. Such natural ventilation may be enhanced by mechanical ventilation, which would also be instrumental in any pressure testing of the unit for the detection of lacerations of the flexible polymer cover elements 10.

In some geographical areas, screens or filters (not seen in the figures) will be required to cover air flow-through openings, demanding increased areas thereof, to ensure the same air flow-through capacity as areas with no screens. This is particularly relevant in areas with a notable insect life or in areas enriched with dust storms or the like.

It is recommended to couple control of the mentioned flap like covers with the overall control of the hydrogen plant inside of the enclosure, such that no operation in terms of hydrogen production is possible with the mentioned automatically operated flap-like covers in a closed state, and also such that no closing of the covers is possible, unless the plant has been completely depressurized and/or all explosive gasses have been flushed out of the plant.

A particular weakness of a flexible cover element comes from it being easy to lacerate. However, simple measures, such as a simple visual inspection of a unit, whenever work at the unit or in its immediate surroundings has taken place would take care of this weakness. A pressure test or an under-pressure test of a unit could also additionally or alternatively be instigated and possibly automated to be performed at regular intervals. This would assure that no larger lacerations are at hand. In such a test, initially all openings are closed, and then the pressure inside of the unit is changed slightly from ambient pressure and the duration of a normalization of the pressure through cracks such as through closed zip-operated openings back to ambient pressure inside the unit is measured.

Built-in or externally mounted reinforcements based on metal wiring is also an option in case better security against lacerations is desired. When placed externally a not too flexible wire mesh could be provided and if a more flexible wire mesh is used, it could be embedded in the flexible polymer cover elements 10.

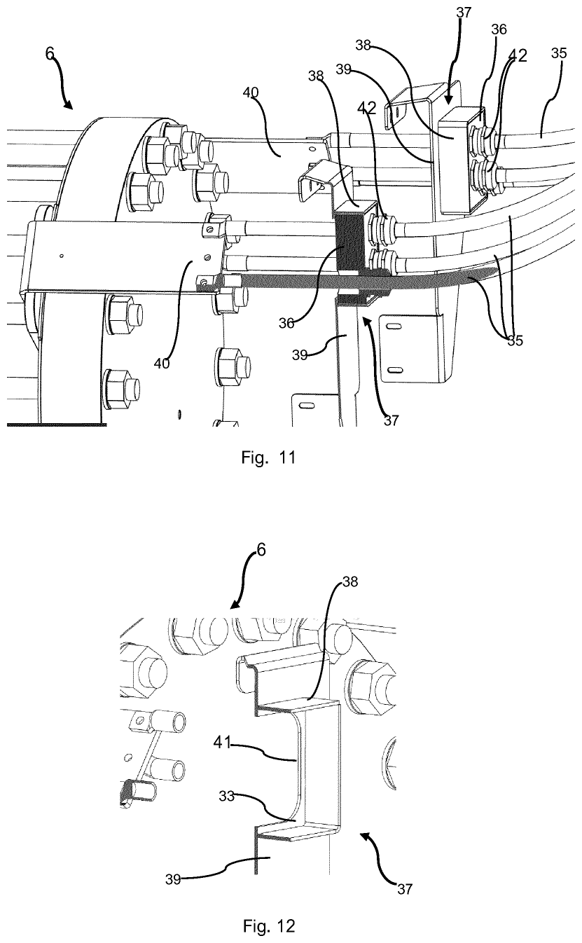

FIG. 11 shows electrical power lines 35 connecting two power supply terminals 40 of an electrolyser stack 6, and the power lines 35 needs to pass through the enclosure 2, and to this end power line feed through blocks 36 are provided, and slidably mounted in slide sockets 37. The slide sockets 37 are arranged to allow the power line feed through blocks 36 movement perpendicular to the enclosure second side 16. The slide sockets 37 comprise a square metal frame 38, mounted on a vertical holder plate 39, and the power line feed through blocks 36 are sized to fit easily and slidably into the metal frame 38. As seen in FIG. 12, a feed through hole 41 in the vertical holder plate 39 is sized a little smaller than the metal frame 38, thereby providing an end-stop 33 for the movement of the power line feed through block 36 in a direction toward the interior 3 of the enclosure 2. Cable fittings 42 attaches each electrical power line 35 to the respective power line feed through block 36, such that any movement of the power supply terminals 40 in an outward direction may be absorbed by the electrical power lines 35 and the feed through blocks 36 and cause no tension in the holder plates or the enclosure 2. Preferably the power line feed through blocks are made from a polymer and electrically insulating material. During pressurization and electrolysation which causes heating, the stack 6 shall become some millimetre longer, and due to the one end being fixated and prevented from movement, the other end, which carries the power supply terminals 40 seen in FIG. 11, shall move and is slidingly arranged to do so.

It is noted that the electrical power lines 35 are to be fed through the power line feed through blocks 36, connected thereto and connected to the power supply terminals 40 while the stack 6 is un-heated and un-pressurised. During pressurisation and heating the power supply terminals 40 shall move towards the enclosure wall, and by the connected electrical power lines, cause the power line feed through blocks 36 to slide in the slide socket 37 in a direction away from the vertical holder plate 39, causing no pressure on this plate 39 and no disturbance of the enclosure 2 part attached thereto. As seen, up to 3 power lines 35 are connected to each power supply terminal, and this measure lends a little more flexibility to the power lines compared to a situation where the electric current was to be carried by a single power cable.

An alternative to the above-described power line feed through with built in movability, would be a power cable loop provided inside of the enclosure between the power supply terminals 40 and a rigid feed through, such that movements could be absorbed in the loop. This solution is less desirable as the inside of the enclosure is stacked with pipes, wiring, valves, control electronics and vessels, all of which need to remain insulated from the high electrical potential in the mentioned loops, and this is anything but easy to do in a safe manner, without increasing the overall footprint of the movable unit 8.

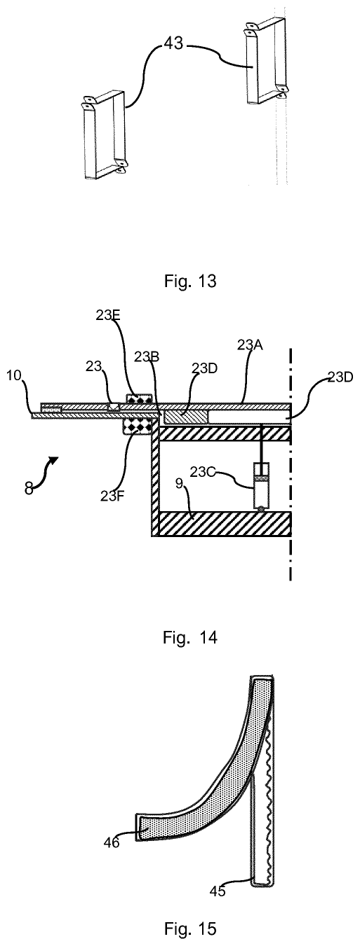

In FIG. 13 two pairs of right-angle brackets 43 are shown. The brackets 43 are also seen in FIG. 10 and are adapted to fit pairwise around the square metal frames 38, seen in FIG. 11 and visible in FIG. 7. During mounting, the flexible polymer cover element 10 and the electrically conductive cover 22 are provided with diagonally running through going cut lines running from corner to corner of the square metal frame 38, and the two layers of enclosure wall material are drawn towards the vertical holder plate 39. This leaves triangular flaps of enclosure wall material along the outside of the metal frames 38, and by mounting the brackets on top of these flaps and screw tightening the brackets in two opposed corners against each other, the enclosure wall materials may be tightly joined to the metal frames 38.

In FIG. 7 electrical cabinets 44 are shown, and they are arranged at the second side 15 of the enclosure, and at the location of the cabinets 44, the enclosure is open with no flexible cover 10 and no electrically conductive cover 22. Thus in FIG. 1, the second side view shows the interior surface 4 of the first side 14 of the enclosure 2 at the site, where the electrical cabinets 44 shall reside when the enclosure is mounted to the movable unit 8.

The flexible polymer cover elements 10 are preferably also heat insulating. For example they are formed in a material or comprises components or layers, which are heat insulating. Thus, in the context of this application, the flexible polymer cover elements 10 could also be called “heat insulating flexible polymer cover elements 10”, flexible and heat insulating polymer cover elements 10, or similar.

It is to be noted that the figures and the above description have shown the example embodiments in a simple and schematic manner. Many of the specific mechanical details have not been shown since the person skilled in the art should be familiar with these details and they would just unnecessarily complicate this description.

### LIST OF PARTS

1 Hydrogen and oxygen generating apparatus
2 Enclosure
3 Interior
4 Interior surface
5 Exterior surface
6 Electrolyser stack
7 Product gasses and electrolyte handling equipment
8 Movable unit
9 Metal frame
10 Flexible polymer cover elements
11 Intermediate profiles
12 First attachment surfaces
13 Second attachment surfaces
14 First side
15 Second side
16 First end side
17 Second end side
18 Upward facing side
19 Upper horizontal frame elements
20 Mounting list
21 Through going fastener
22 Electrically conductive cover
23 Zip operated opening
23A Flap like covers
23B Air flow through areas
23C Actuator
23D Frame like piece
23E Magnet fastened to flap like cover
23F Magnet fasted to metal frame or intermediate profiles
24. Tongue element
25 Lower edges
26. Zip operated opening with tongue
27. Downward sloping angle
28. Drip pan
29. Rafters
30. Gable roof
31. Length axis centreline
32. Apex of V shaped profile
33. End stop
34. Separators
35. Electrical power line
36. Power line feed through block
37. Slide socket
38. Square metal frame
39. Vertical holder plate
40. Power supply terminals
41. Feed through hole
42. Cable Fittings
43. Right angle brackets
44. Electrical cabinets
45. Un-pressurized polymer hose
46. Pressurised polymer hose

1.-13. (canceled)

14. A method of enclosing a hydrogen and oxygen generating apparatus in an enclosure, the enclosure comprising a metal frame part, an interior, an interior surface, and an exterior surface, wherein the hydrogen and oxygen generating apparatus includes at least one electrolyser stack adapted for electrolysing water to hydrogen product gas and oxygen product gas, and product gases and electrolyte handling equipment, the method comprising:
assembling and mounting the hydrogen and oxygen generating apparatus in the metal frame part; and
adding and securing heat insulating flexible polymer cover elements to the metal frame part.

15. The method according to claim 14, further comprising:
adding intermediate profiles onto the metal frame by attaching first attachment surfaces of the intermediate profiles to the metal frame;
securing the flexible polymer cover elements to second attachment surfaces of the intermediate profiles on sides of the metal frame and on upward facing surfaces of the metal frame;
providing mounting lists externally of the flexible polymer cover elements along the intermediate profiles; and
attaching the mounting list to the flexible polymer cover elements by through going fasteners adapted to pierce the mounting lists, the flexible cover element, and the second attachment surfaces of the intermediate profiles.

16. The method according to claim 15, wherein zip operated openings are provided, the zip operated openings allowing access through the flexible polymer cover elements to the interior of the enclosure.

17. The method according to claim 14, wherein an electrically conductive cover is added along with the flexible polymer cover elements and secured to the metal frame part.

18. The method according to claim 17, further comprising:
adding intermediate profiles onto the metal frame by attaching first attachment surfaces of the intermediate profiles to the metal frame;
securing the flexible polymer cover elements to second attachment surfaces of the intermediate profiles on sides of the metal frame and on upward facing surfaces of the metal frame;
providing mounting lists externally of the flexible polymer cover elements along the intermediate profiles; and
attaching the mounting list to the flexible polymer cover elements by through going fasteners adapted to pierce the mounting lists, the flexible cover element, the electrically conductive cover and the second attachment surfaces of the intermediate profiles.

19. The method according to claim 18, wherein zip operated openings are provided, the zip operated openings allowing access through the flexible polymer cover elements and the electrically conductive cover to the interior of the enclosure.

20. The method according to claim 14, further comprising extending tongue elements of lower edges of at least one opening into the interior of the enclosure at a downward sloping angle with respect to a horizontal plane.

21. An enclosure adapted for enclosing a hydrogen and oxygen generating apparatus, the enclosure comprising:
a metal frame part;
an interior;
an interior surface; and
an exterior surface;
wherein the hydrogen and oxygen generating apparatus includes:
at least one electrolyser stack adapted for electrolysing water to hydrogen product gas and oxygen product gas and accompanying gas; and
electrolyte handling equipment;
wherein the hydrogen and oxygen generating apparatus is arranged in the metal frame part;
wherein the exterior surface of the enclosure comprises at least a heat insulating flexible polymer cover element which is attached to the metal frame part.

22. The enclosure according to claim 21, wherein intermediate profiles are attached onto the metal frame through first attachment surfaces of the intermediate profiles, and where the flexible polymer cover elements are adapted to abut second attachment surfaces of the intermediate profiles on sides and upward facing side of the metal frame, and wherein mounting lists are adapted to be secured externally of the flexible polymer cover elements along the intermediate profiles by through going fasteners adapted to pierce the mounting lists, the flexible cover element and the second attachment surfaces of the intermediate profiles.

23. The enclosure according to claim 22, wherein electrically conductive covers are arranged to extend along with the flexible polymer cover elements and are fixated with the flexible polymer cover elements between the mounting lists and the second attachment surfaces of the intermediate profiles.

24. The enclosure according to claim 23 wherein zip operated openings are provided to allow access through the flexible polymer cover elements to the interior of the enclosure.

25. The enclosure according to claim 24 wherein an electrically conductive cover is provided along with the flexible polymer cover element and secured to the metal frame part.

26. The enclosure according to claim 21, wherein tongue elements of lower edges of at least one opening extend into the interior of the enclosure at a downward sloping angle with respect to a horizontal plane.
